(19) United States
(12) Patent Application Publication
(10) Pub. No.: US 2007/0261027 A1
(43) Pub. Date: Nov. 8, 2007

(54) METHOD AND SYSTEM FOR AUTOMATICALLY DISCOVERING AND POPULATING A PALETTE OF REUSABLE DIALOG COMPONENTS

(75) Inventors: GIRISH DHANAKSHIRUR, DELRAY BEACH, FL (US); JEFFREY S. KOBAL, LAKE WORTH, FL (US); FELIPE GOMEZ, WESTON, FL (US); ROCCO F. PALERMO JR., BOYNTON BEACH, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/382,186

(22) Filed: May 8, 2006

(51) Int. Cl. G06F 9/44

(52) U.S. Cl. 717/113; 717/109

(57) ABSTRACT

The present invention permits a speech application design tool to dynamically acquire information for runtime components, such as Reusable Dialog Components (RDCs). More specifically, a user can identify a library available to the runtime environment that includes runtime speech components. Runtime components can be imported into an integrated development environment (IDE) that includes the software design tool. The tool can discover configuration grammars, audio, and data models associated with the imported components. When previously developed application code has been loaded into the tool, versions of components associated with the previously developed application will be compared and synchronized with the library components. Differences can be flagged by the tool, which facilitates a component upgrading process. Otherwise, a palette within the tool will be populated with the imparted components, which can be used when authoring a new application.

### BACKGROUND

1. Field of the Invention

The present invention relates to the field of speech processing technologies, and, more particularly, to a method and system for discovering and populating a palette of reusable dialog components.

2. Description of the Related Art

Speech application development is evolving to utilize dynamically generated VoiceXML, which permits speech to be cost-effectively added to Web applications without sacrificing the quality of a resulting speech user interface (SUI). Reusable Dialog Components (RDCs) are of central importance to this technological evolution.

RDCs are pre-built speech software components, or building blocks, that handle basic functions, such as date, time, currency, locations and the like. For example, RDCs can include often-used functions that allow a caller to book a flight using an auto-agent over the phone. Multiple RDCs can be aggregated to provide higher levels of user functionality. RCDs encourage software reuse, modular development of applications, and applications having independently updatable components.

That is, each RDC used by an application can be updated independent of other application updates so long as interface specifications for the updated RDC remain unchanged. For example, a grammar and/or audio used by one or more RDCs can be upgraded to take advantage of a new speech recognition technology or to implement a desired function. The upgraded RDCs can directly replace previous versions of the RDCs, which thereby upgrade functionality of one or more applications that use the RDCs.

RDCs can be implemented as JAVA Server Page (JSP) tags that enable dynamic development of voice applications and multimodal user interfaces. JSPs that incorporate RDC tags can automatically generate W3C VoiceXML complaint code at runtime. As such, RDCs provide a standard basis for speech applications. A collection of RDCs following standards and documented interface parameters can allow developers to build speech components that will interoperate, regardless of the vendor that created the RDCs or speech components. Each RDC can operate in a semi-autonomous manner, having its own dialog management code, grammars, prompts, audio, and the like.

RDCs are typically deployed to a runtime environment for dynamic operation when a speech-enable application is loaded. RDCs are also accessed from within a software development environment when applications utilizing RDCs are designed. Problems can result when the RDCs accessed in the software development environment are different and incompatible from the RDCs contained within a runtime environment.

Venders and third party developers are constantly developing and deploying new RDCs. A disconnect currently exists between the runtime environment and the development environment with regard to RDCs. Specifically, software development tools usually ship with a toolkit of RDCs, which can be used during software development. Current software development tools, however, are not being constantly updated to reflect new RDCs which are available and used within a runtime environment. As a result, new software is often developed that includes older versions of RDCs or that fail to take full advantage of capabilities contained within a recently developed RDCs.

Additionally, different software development tools make different RDCs available to software developers. A user of applications developed with different software development tools often locally stores and utilizes different and largely redundant RDCs. If a user utilizes multiple applications having RDCs, user computing resources can be needlessly consumed due to a lack of conformity bet ween different speech enabled applications with regards to RDCs. In short, software developers are not currently provided with tools that help them identify new RDCs and/or that facilitate upgrading versions of RDCs used within existing applications to newer RDC versions.

### SUMMARY OF THE INVENTION

The present invention permits a speech application design tool to dynamically acquire information for runtime components, such as Reusable Dialog Components (RDCs). More specifically, a user can identify a library available to the runtime environment that includes one or more runtime speech components or runtime speech fragments. Runtime components/fragments can be imported into an integrated development environment that includes the design tool. The tool can discover configuration, grammars, audio, and data models associated with the imported components.

When previously developed application code has been loaded into the design tool, versions of runtime components associated with the previously developed application will be compared and synchronized with the library components. Differences can be flagged by the tool, which facilitates a component upgrading process. Components can be upgraded, repackaged, and redeployed for the application without breaking a contract with the published libraries.

Otherwise, a palette within the design tool will be populated with the imported components which can be used when authoring a new application. A developer can use palette components to create/edit/modify the application being developed. The developer can use the design tool to convert graphically created communication flows and other graphically represented design selections into executable code. The executable application code can utilize at least one runtime component, which can be deployed to the runtime environment, where the runtime component dynamically generates VoiceXML code as appropriate.

The present invention can be implemented in accordance with numerous aspects consistent with material presented herein. For example, one aspect of the present invention can include a method for integrating runtime components into a software development tool. The method can include a step of providing a software development tool for developing voice applications. The tool can include a canvas for graphically building communication flows and a palette of runtime components that are able to be added to the canvas and integrated with graphically built communication flows. The software development tool can automatically create code for a voice application based upon graphically built communication flows. A library that includes at least one runtime component can be identified. The software development tool can automatically and dynamically discover the runtime component from the identified library. The software development tool can automatically and dynamically populate the palette with the discovered runtime component. The software development tool can be automatically configured to enable a user to utilize the newly populated runtime component from the palette.

Another aspect of the present invention can include a method for updating runtime components that generate VoiceXML code for voice-enabled applications. The method can load application source code into a software development tool, where the application source code is associated with an application set of runtime components, wherein the runtime components generate VoiceXML code. A library including at least one library runtime component can be identified. Versions of the application set can be compared to versions of corresponding ones of the library runtime components. A determination can be made based upon the comparing step that indicates at least one of the runtime components in the application set has an upgraded version located within the library. The runtime component of the application set can be dynamically upgraded with a corresponding runtime component from the library using the software development tool. A compiled or otherwise executable form of the application source code along with the upgraded runtime components can be redeployed into a runtime environment.

Yet another aspect of the present invention can include a software tool for developing speech-enabled applications. The tool can include a canvas, a palette, and an import function. The canvas can be used to graphically build communication flows. The palette can include runtime components that are able to be added to the canvas and integrated with graphically built communication flows. The import function can import runtime components from a runtime library containing a set of runtime components. The runtime library can include runtime component configuration, grammar, audio, and data model information. For example, the runtime components include at least one reusable dialog component that dynamically generates VoiceXML when deployed in the runtime environment. The software development tool can automatically create code for a voice application based upon graphically built communication flows interactively presented in the canvas.

It should be noted that various aspects of the invention can be implemented as a program for controlling computing equipment to implement the function described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a flow chart of a method for a tool of an integrated design environment (IDE) to discover and use runtime components of a runtime environment in accordance with an embodiment of the inventive arrangements disclosed herein.

FIG. 2 is a system that automatically discovers and populates an IDE palette with runtime components from a runtime library in accordance with an embodiment of the inventive arrangements disclosed herein.

FIG. 3 shows a software development tool for creating voice-enabled applications using runtime components obtained from a runtime library in accordance with an embodiment of the inventive arrangements disclosed herein.

### DETAILED DESCRIPTION OF THE INVENTION

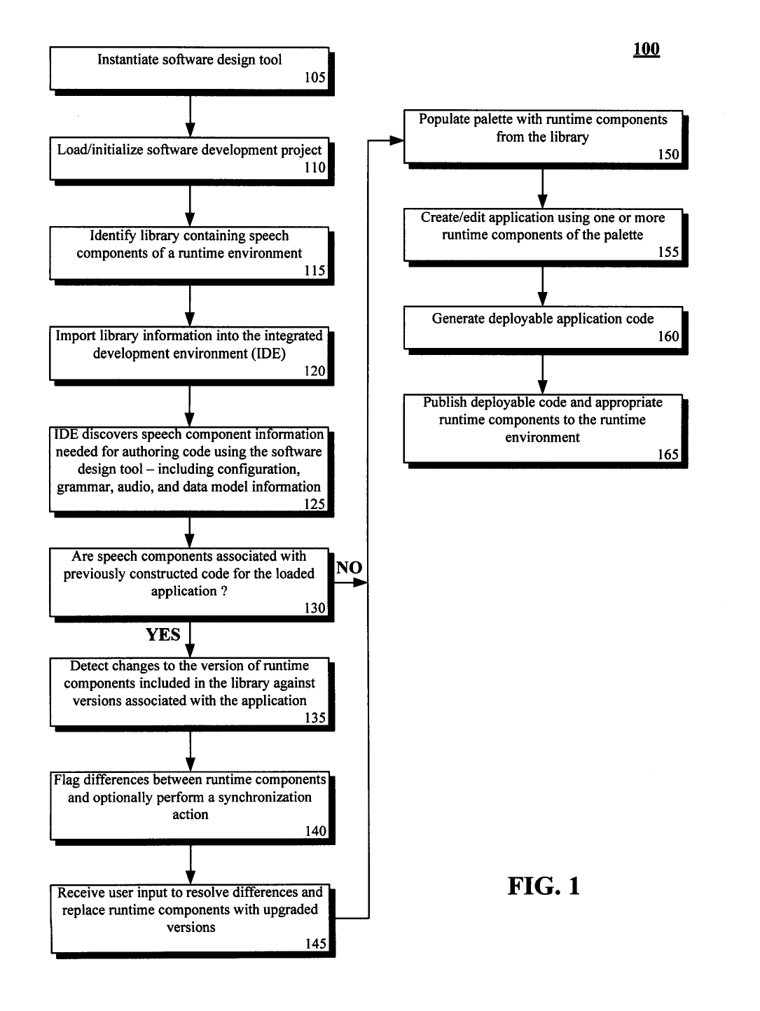

FIG. 1 is a flow chart of a method 100 for a tool of an integrated design environment (IDE) to discover and use runtime components of a runtime environment in accordance with an embodiment of the inventive arrangements disclosed herein. Method 100 can be performed in the context of an IDE for developing speech-enabled Web applications that utilize Reusable Dialog Components (RDCs) or similar runtime components.

In one embodiment, the IDE can include tools for designing standards-based enterprise Web applications conforming to a JAVA2 Platform Enterprise Edition (J2EE) programming model. The tools can, for example, include the IBM VOICE TOOLKIT. Accordingly, tools used for method 100 can include RATIONAL Application Developer (RAD) or RATIONAL Web Developer (RWD). Moreover, a palette described in method 100 can be a palette of IBM's COMMUNICATION FLOW BUILDER. The inventive arrangement s described herein, however, are not limited in this regard and can be utilized in the context of any IDE that utilizes runtime components, such as RDCs, to create/modify speech enabled applications

Method 100 can begin in step 105, where a software design tool can be instantiated. In step 110, the software design tool can be used to load a previously saved software development project or to initialize a new software project. In step 115, a library containing speech components used in a runtime environment can be identified. For example, a user can use the design tool to retrieve a JAR file containing speech components. The speech components can include one or more RDCs.

In step 120, library information can be imported from the runtime environment to the IDE. In step 125, the IDE can discover speech component information needed for authoring code using the software design tool. Component information can include configuration, grammar, audio, and data model information. In step 130, a determination can be made as to whether speech components of a previously saved and currently loaded project exist.

When previous components do exist, the method can proceed to step 135, where changes between versions of the runtime components associated with the loaded application and versions contained within the library can be detected. In step 140, differences between the runtime components can be flagged. Further, one or more optional synchronization actions can be performed. The synchronization action can maintain the contract between the originally associated runtime component and the application. In step 145, user input can be received via the software design tool that resolves flagged differences and that replaces the runtime components with upgraded versions. Previously specified runtime component parameters can be filled for a new component based upon the values specified for the old component. New parameters contained within the upgraded component can be set to default values and/or a user can be prompted to provide values for new parameters. The method can proceed from step 145 to step 150.

When in step 130 previous components do not exist, the method can skip from step 130 to step 150, where a palette can be populated with runtime components obtained from the library. When added to the palette, all configuration information can be automatically added for each runtime component to permit the software development tool to utilize the palette components. In step 155, a speech-enabled application can be created/edited using one or more of the runtime components of the palette. In one embodiment, palette items can be dropped and dragged onto the canvas to add the selected items to a communication flow shown in the canvas.

In step 160, the software development tool can automatically generate deployable application code based upon the design elements interactively placed upon the canvas. In step 165, the deployable code can be published along with appropriate runtime components to the runtime environment.

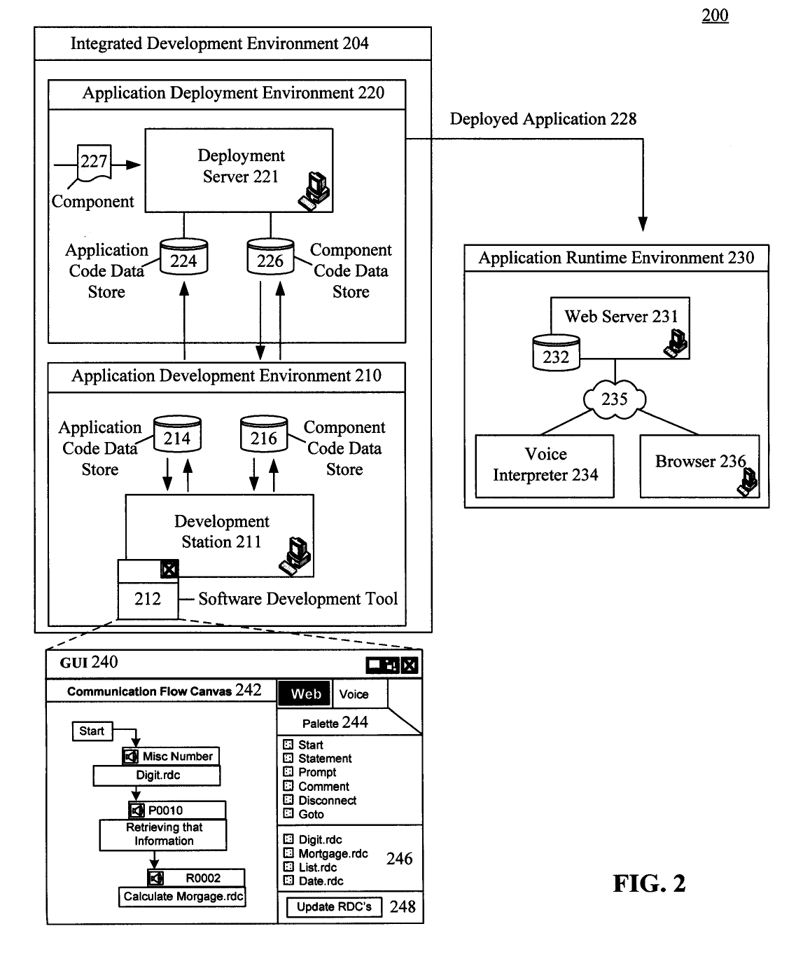

FIG. 2 is a system 200 that automatically discovers and populates an IDE palette with runtime components from a runtime library in accordance with an embodiment of the inventive arrangements disclosed herein. System 200 can be one contemplated system capable of performing method 100.

In system 200, speech-enabled applications can be developed in an integrated development environment 204 and deployed to an application runtime environment 230. The application runtime environment 230 can include a Web-based environment where a Web server 231 serves Web pages constituting the deployed application 228 to browser 236.

Browsers 236 can include any program that enables a user to view or interact with World Wide Web documents, such as those served by Web server 231. Browser 236 can include, for example, a visual Web browser, a multimodal browser, and a voice only browser.

Voice interpreter 234 can generate audio presented to a user of browser 236 and can convert audio from the user into computer understandable responses. The voice interpreter 234 can be a computer program that interprets VoiceXML code provided by the Web server 231. The Web server 231, voice interpreter 234, and browser 236 can be communicatively linked through network 235.

A portion of the VoiceXML code interpreted by voice interpreter 234 can be dynamically generated VoiceXML code generated by a runtime component, such as a reusable dialog component (RDC). These reusable dialog components can be stored in data store 232 and can be accessed by Web server 231 as needed, which is determined by calls from a speech-enabled application to the various RDCs contained in data store 232.

Each deployed voice-enabled application 228 can be an application developed within the application development environment 210. Environment 210 can include one or more development stations 211. In a group development effort, different group members working from different development stations 211 can each be responsible for a portion of an integrated software project. Each deployment station 211 can store application code in application code store 214 and can store runtime components in data store 216.

Software development tools 212 can reside on the development station 211, which software developers can utilize. One such software development tool 212 can include IBM's Voice toolkit with RDC capabilities. Other toolkits provided by other venders can be used as the software development tool 212.

In one embodiment, the software development tool 212 can include GUI 240, which includes a communication flow canvas 242 and a palette 244. Different palette 244 elements can be dropped and dragged into the canvas 242 to graphically construct a communication flow for a speech-enabled application. Palette 244 controls can, for example, include controls for a flow start, statements, prompts, comments disconnect, goto, and the like.

A different section 246 of the palette 244 can include RDC components, such as digit.rdc, mortgage.rdc, list.rdc, and date.rdc. As shown in GUI 240, the digit.rdc and the mortgage.rdc components have been added to canvas 242. One or more of the RDCs in palette section 246 can be imported from a runtime library. For example, component 227 can represent the mortgage.rdc, which is dynamically obtained from a runtime library.

More specifically, server 221 can retrieve component 227 from a runtime library and store it in data store 226. When the software development tool 212 is instantiated, data store 216 and 226 can be synchronized. Palette 244 can be populated from components in data store 216, which now includes component 227. Alternatively, a user can explicitly retrieve runtime component 227 from component data store 226, such as by selecting a JAR file containing component 227. Upon retrieval, software tool 212 can add component 227 to palette section 246.

GUI 240 can also include a function 248 that updates RDCs using RDC versions contained within a runtime library. The RDC update and/or RDC synchronization function 248 can be a fully automated, a semi-automated, and/or a manual process.

After an application has been constructed using software development tool 212, executable code can be generated. This generated code can be conveyed to the deployment server 221 and placed in data stores 224 and/or 226. Quality control checks and/or testing operations can be conducted within the application development environment 220. After passing the necessary tests, the speech-enabled application can be deployed to the application runtime environment 230.

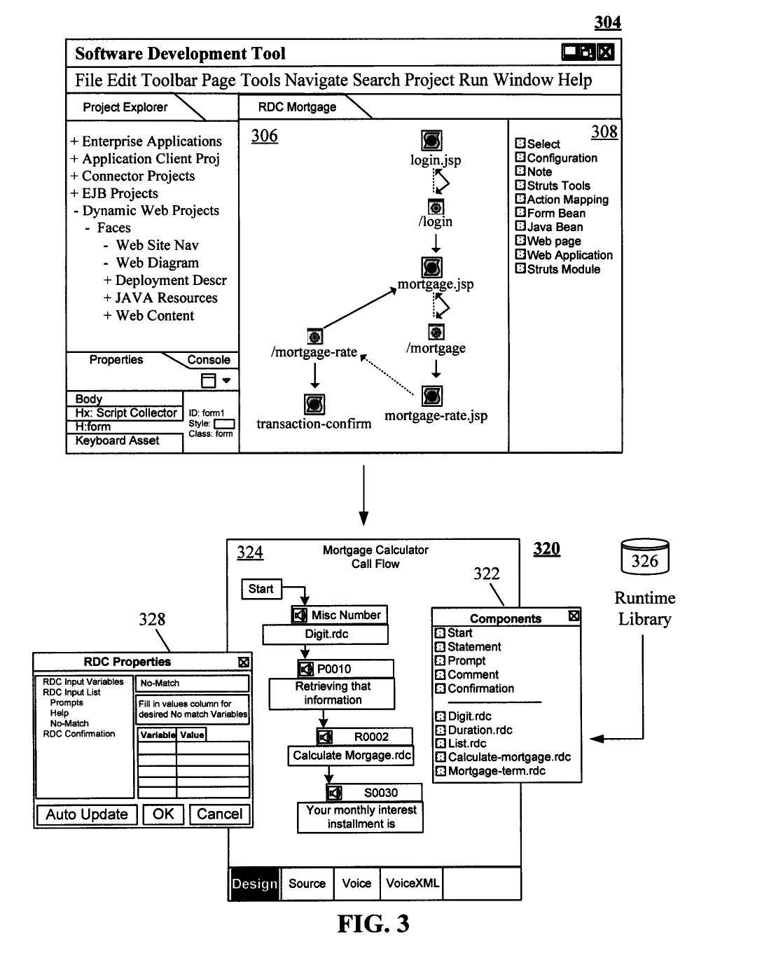

FIG. 3 shows a software development tool for creating voice-enabled applications using runtime components obtained from a runtime library in accordance with an embodiment of the inventive arrangements disclosed herein. In one embodiment, the tool detailed in FIG. 3 can be an implementation of software development tool 212 from FIG. 2.

Interface 304 shows a software development tool used to develop multi-tiered J2EE compliant applications and ENTERPRISE JAVA BEAN (EJB) components. Interface 304 includes section 308 that provides support for STRUTS-based application development. As shown in section 306 of interface 304, a Model-View-Controller (MVC) based application can be designed in which the Model is a JAVA BEAN, the controller is a set of action classes with configuration files, and the View is a JSP page rendering the user interface.

Interface 320 shows a call flow building view of the software development tool. Interface 320 can include a canvas section 324 and a palette 322 of components, which can be added to the canvas 324. The palette 322 can include one or more runtime components dynamically obtained from runtime library 326.

Once an RDC component from the palette 322 is placed in the canvas 324, it can be automatically configured with default values. These values can be overridden using a RDC properties window 328. Each RDC can have an extensive set of customizable properties accessible through window 328 including help, no-match, no-input 1, no-input-2, and no-input3 to name a few.

When a previously saved application is loaded into interface 320, the runtime library 326 can be checked for new versions of previously utilized RDCs. When new versions are found, a user can be prompted to update the RDCs. When RDCs are updated, previously established properties from the out-of-date RDC can be used to set equivalent properties of the new, updated RDC.

Application calls to the updated RDCs can be maintained based upon calls established for the corresponding out-of-date RDCs. A user can be explicitly flagged when differences exist between RDCs that require new properties be specified. Users can be flagged/prompted to resolve potential problems with an updated RDC resulting from new interface parameters. Further, if the new RDC provides new capabilities, a user can be notified of these capabilities.

It should be appreciated that interfaces 240, 304, and 320 are provided to demonstrate concepts described for an embodiment of the inventive arrangements disclosed herein. Interfaces 240, 304, and 320 are not intended to constrain the scope of the invention to a particular contemplated expression. Derivatives of interfaces 240, 304, and 320 including different interface elements, arrangements, layouts, and the like are contemplated herein.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for integrating runtime components into a software development tool comprising:
providing a software development tool for developing voice applications, said tool including a canvas for graphically building communication flows and a palette of runtime components that are able to be added to the canvas and integrated with graphically built communication flows, wherein the software development tool automatically creates code for a voice application based upon graphically built communication flows;
identifying a library including at least one runtime component;
the software development tool automatically and dynamically discovering the at least one runtime component from the identified library;
the software development tool automatically and dynamically populating the palette with the discovered at least one runtime component; and
automatically configuring the software development tool to enable a user to utilize the newly populated runtime component from the palette.

2. The method of claim 1, further comprising:
generating a deployable application that includes the newly populated runtime component, wherein the application is based upon a communication flow graphically constructed using the software development tool.

3. The method of claim 2, wherein the deployed runtime component associated with the deployable application dynamically generates VoiceXML code for the application.

4. The method of claim 1, wherein the newly populated runtime component is a reusable dialog component of a J2EE based platform.

5. The method of claim 4, wherein the identified library resides in a server, wherein the software development tool is disposed in a client, wherein the server centrally maintains a component repository of reusable dialog components, and wherein a plurality of clients including the client periodically and dynamically synchronize with the component repository, whereby software development tools residing in the clients all utilize a centrally managed set of reusable dialog components.

6. The method of claim 1, wherein the newly populated runtime component includes dialog management code, at least one grammar, at least one prompt, and audio.

7. The method of claim 1, wherein the library comprises a JAR file that includes at least one reusable dialog component.

8. The method of claim 1, wherein the software development tool is a tool of an integrated development environment, wherein the identified library is maintained in a repository external to the integrated development environment.

9. The method of claim 1, further comprising:
loading application source code into the software development tool, wherein the application source code is associated with an application set of runtime components;
automatically querying the library for library runtime components corresponding to runtime components for differences between corresponding runtime components; and
dynamically performing at least one synchronization action to reconcile the differences.

10. The method of claim 9, wherein the at least one synchronization action presents a notification to a user of the software development tool regarding the queried differences.

11. The method of claim 9, wherein the at least one synchronization action flags the queried differences for the software development tool to facilitate upgrading runtime components of the loaded application.

12. The method of claim 1, wherein said steps of claim 1 are performed by at least one machine in accordance with at least one computer program having a plurality of code sections that are executable by the at least one machine.

13. A software tool comprising:
a canvas for graphically building communication flows;
a palette of runtime components that are able to be added to the canvas and integrated with graphically built communication flows; and
an import function for importing runtime components from a runtime library of runtime components, wherein the runtime library includes runtime component configuration, grammar, audio, and data model information, wherein the software development tool automatically creates code for a voice application based upon graphically built communication flows interactively presented in the canvas, and wherein the runtime components include at least one reusable dialog component that dynamically generates VoiceXML when deployed in the runtime environment.

14. The software tool of claim 13, wherein the import function automatically and dynamically populates the palette with at least one runtime component imported from the runtime library.

15. The software tool of claim 13, wherein the import function automatically determines differences between runtime components in the palette and imported runtime components from the runtime library and dynamically and automatically performs a synchronization action to help resolve the determined differences.

16. A method for updating runtime components that generate VoiceXML code for voice-enable applications comprising:
loading application source code into a software development tool, where the application source code is associated with an application set of runtime components, wherein the runtime components generate VoiceXML code;
identifying a library including at least one library runtime component;
comparing versions of the application set to corresponding ones of the library runtime component;
automatically determining from the comparing step that at least one of the runtime components in the application set has an upgraded version located within the library;
dynamically upgrading the runtime component of the application set with a corresponding runtime component from the library.

17. The method of claim 16, further comprising:
determining application specific settings of a runtime component that is about to be upgraded; and
automatically applying the determined application specific settings to the runtime component after the upgrading step is performed.

18. The method of claim 16, further comprising:
flagging differences between a runtime component of the application set that is to be upgraded and a corresponding runtime component from the application library; and
presenting the flagged differences to a user of the software development tool before the upgrading step.

19. The method of claim 16, wherein the runtime component is a reusable dialog component.

20. The method of claim 16, further comprising:
the software development tool automatically and dynamically discovering the at least one runtime component in the identified library, which was not presented within the software development tool when the application associated with the loaded application code was originally developed;
the software development tool automatically and dynamically populating a palette with the discovered at least one runtime component; and
automatically configuring the software development tool to enable a user to utilize the newly populated runtime component from the palette.
